(19) United States
(12) Patent Application Publication
(10) Pub. No.: US 2014/0365286 A1
(43) Pub. Date: Dec. 11, 2014

(54) Method of Reserving an Electronic Savings Advertisement

(71) Applicant: Matthew Louis Samoville, Folsom, CA (US)

(72) Inventor: Matthew Louis Samoville, Folsom, CA (US)

(21) Appl. No.: 14/299,448

(22) Filed: Jun. 9, 2014

Related U.S. Application Data
(60) Provisional application No. 61/956,389, filed on Jun. 7, 2013.

(51) Int. Cl. G06Q 30/02

(52) U.S. Cl. CPC G06Q 30/0249; G06Q 30/0268; G06Q 30/0222
USPC 705/14.23; 705/14.48

(57) ABSTRACT

A method of reserving a savings advertisement includes: delivering an electronic savings advertisement creation interface web page from a server system to a computer system of a merchant; receiving at the server system a request from the computer system of the merchant to generate an electronic savings advertisement, the request comprising a maximum number of transactions that can be conducted with the electronic savings advertisement; storing in the server system a value representing an available numeric quantity for the savings advertisement; determining in the server system whether the numeric quantity is greater than zero; delivering an electronic savings advertisement request interface web page from the server system to a computer system of a customer, the savings advertisement request interface web page including an offer for the savings advertisement; receiving at the computer system of the customer a reservation request for the electronic savings advertisement; and decrementing the available numeric quantity by one in the server system in response to the reservation request.

### CROSS-REFERENCE TO RELATED APPLICATIONS

This application claims priority to U.S. Provisional Application Ser. No. 61/956,389, filed on Jun. 7, 2013, the entire disclosures of which are incorporated by reference.

### BACKGROUND

The innovation of Internet Technology (IT) and portable devices, such as Smartphones and Tablets, has brought about profound changes in the way we conduct our daily lives. One of such changes is the way in which we receive, view, and interact with advertisements. In particular, online savings advertisements have become a trend in recent years. For example, online vouchers and online coupons have become a popular trend in a number of nations, as well as other savings advertisements that convey the news of promotional rates, such as sales, that are offered in brick and mortar establishments.

There have been a number of platforms developed for creating, delivering, and viewing advertisements of the like. However, the majority of such platforms are limited by means of the degree of control a business manager has in creating and/or managing savings advertisements. For example, there are currently few platforms that enable business managers the ability to limit the available quantity of an advertisement.

The advantage of limiting the quantity of a savings advertisement is that it allows businesses to determine a budget for a particular promotion that can not be exceeded. For example, a merchant can set a budget of $2,000 for a particular promotion by creating an advertisement for a $100 discount on a purchase, and limiting the quantity to 20 uses or redemptions. More importantly, such a marketing scheme enables merchants to generate a “buzz”, an increase in word-of-mouth and/or social media publicity, by offering higher savings to a lesser number of consumers, as opposed to lower savings to a higher number of consumers.

While there currently are platforms that provide, in various ways, the ability to limit a savings advertisement to a specific quantity, there is no platform providing a system that enables consumers to reserve a savings advertisement of limited quantity such as by retaining the ability to use a savings advertisement at a later time. Such a system would provide consumers the advantage of being able to acquire savings using reserved advertisements in future purchases, for example, in case an individual does not have time to take advantage of a savings advertisement at a given time or if an individual is undecided as to whether or not she or he wants to respond to an advertisement at a given time but does not want to lose the opportunity. Accordingly, a consumer can reserve a savings advertisements that is limited in quantity, and save money during a purchase at a later time at the consumer's convenience and discretion.

### SUMMARY

In general, one innovative aspect of the subject matter described in this specification can be implemented in methods that include a method of reserving an electronic savings advertisement. The method comprises: delivering an electronic savings advertisement creation interface web page from a server system to a computer system of a merchant; receiving at the server system a request from the computer system of the merchant to generate an electronic savings advertisement, the request comprising a maximum number of transactions that can be conducted with the electronic savings advertisement; storing in the server system a value representing an available numeric quantity for the savings advertisement; determining in the server system whether the numeric quantity is greater than zero; delivering an electronic savings advertisement request interface web page from the server system to a computer system of a customer, the savings advertisement request interface web page including an offer for the savings advertisement; receiving at the computer system of the customer a reservation request for the electronic savings advertisement; and decrementing the available numeric quantity by one in the server system in response to the reservation request.

Another innovative aspect of the subject matter described in this specification can be implemented in methods that include a method of reserving a savings advertisement. The method comprises: delivering an electronic savings advertisement creation interface web page from a server system to a computer system of a merchant or a computer system of an administrator, the electronic savings advertisement creation interface web page providing means for creating different types of savings advertisements; receiving at the server system a request from the computer system of the merchant or the computer system of the administrator to generate an electronic savings advertisement, the request comprising a maximum number of transactions that can be conducted with the electronic savings advertisement; storing in the server system a value representing an available numeric quantity for the electronic savings advertisement; determining in the server system whether the numeric quantity is greater than zero; delivering an electronic savings advertisement transaction interface web page from the server system to a computer system of a customer, the savings advertisement transaction interface web page including an offer for the savings advertisement, means for conducting a transaction with the savings advertisement enabling a customer to receive a discount on a good or service either during a purchase at a point of sale or during a future purchase, and means for conducting a transaction to create an electronic record of the savings advertisement; decrementing the available numeric quantity by one in the server system in response to each transaction conducted with the savings advertisement; restricting another customer from conducting a transaction with the savings advertisement if the available numeric quantity is zero; receiving at the computer system of the customer the electronic savings advertisement record; and providing in the electronic savings advertisement transaction interface web page means for locating the electronic savings advertisement record means for conducting a transaction with the electronic savings advertisement record enabling a customer to receive a discount on a good or service either during a purchase at a point of sale or during a future purchase.

These and other implementations can each optionally include one or more of the following features. The method can further comprise: restricting another customer from making a reservation request for the savings advertisement if the available numeric quantity is zero. The method can further comprise: providing on the server system means for uniquely identifying a customer while using the electronic savings advertisement request interface web page; providing on the electronic savings advertisement creation interface web page means for associating with an electronic savings advertisement restrictions criteria; receiving at the server system a request from the computer system of the merchant or the computer system of the administrator to generate an electronic savings advertisement, the request comprising restrictions criteria; and providing on the electronic savings advertisement transaction interface web page means for automatically restricting the number of reservation requests conducted for the savings advertisement according to the associated restrictions criteria. The method can further comprise: storing a maximum transaction time, determining whether the maximum transaction time has passed from the time of the reservation request without the electronic savings advertisement request being used by the customer, and incrementing the available numeric quantity by one in the server system. The method can further comprise: delivering an electronic savings advertisement transaction interface web page from the server system to the computer system of the customer, the savings advertisement transaction interface web page including an offer for the savings advertisement and means for conducting a transaction with the savings advertisement enabling a customer to save money on a good or service either during a purchase at a point of sale or during a future purchase; and decrementing the available numeric quantity by one in the server system in response to the transaction enabling a customer to save money on a good or service. The method can further comprise: delivering an electronic savings advertisement transaction interface web page from the server system to a portable web-enabled device of the customer, the savings advertisement transaction interface web page including an offer for the savings advertisement and means for receiving at the portable device of the customer a reservation request for the electronic savings advertisement; and decrementing the available numeric quantity by one in the server system in response to the reservation request. The method can further comprise: providing in the electronic savings advertisement transaction interface web page means for conducting a transaction with the savings advertisement enabling a customer to save money on a good or service either during a purchase at a point of sale or during a future purchase; and decrementing the available numeric quantity by one in the server system in response to the transaction conducted with the savings advertisement enabling a customer to save money on a good or service. The method can further comprise: providing on the server system means for uniquely identifying a customer while the customer is using the electronic savings advertisement transaction interface web page;

providing on the electronic savings advertisement creation interface web page means for associating with an electronic savings advertisement restrictions criteria; receiving at the server system a request from the computer system of the merchant or the computer system of the administrator to generate an electronic savings advertisement, the request comprising restrictions criteria; and providing on the electronic savings advertisement transaction interface web page means for automatically restricting the transactions conducted with the savings advertisement according to the associated restrictions criteria. The method can further comprise: storing a maximum transaction time, determining whether the maximum transaction time has passed from the time of the transaction to generate the electronic record without a transaction being conducted with the electronic savings advertisement record enabling a customer to receive a discount on a good or service; and incrementing the available numeric quantity by one in the server system. The method can further comprise: providing on the server system means for uniquely identifying a customer while the customer is using the electronic savings advertisement transaction interface web page; and providing on the server system means for enabling the customer to conduct another transaction to create an electronic record of the savings advertisement after the maximum transaction time has passed. The method can further comprise: delivering an electronic savings advertisement transaction interface web page from the server system to a portable web-enabled device of the customer, the savings advertisement transaction interface web page including an offer for the savings advertisement, means for conducting a transaction with the savings advertisement enabling a customer to receive a discount on a good or service either during a purchase at a point of sale or during a future purchase, and means for means for conducting a transaction to create an electronic record of the savings advertisement; receiving at the portable device of the customer the electronic savings advertisement record; and providing in the electronic savings advertisement transaction interface web page means for locating the electronic savings advertisement record and means for conducting a transaction with the electronic savings advertisement record enabling a customer to receive a discount on a good or service either during a purchase at a point of sale or during a future purchase.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example system for creating, editing, locating, printing, purchasing, reserving, and tracking electronic incentive-based advertisements.

FIG. 2 illustrates example home page user interface that can be used by a business manager, a system administrator, or a customer to locate an advertisement and/or log in to a user account on the system.

FIG. 3 illustrate an example user interfaces that can be used by a business manager or system administrator to create an electronic advertisement.

FIGS. 4 to 8 illustrate example user interfaces that can be used by a customer to locate and/or conduct a transaction with an advertisement or advertisement record.

FIGS. 9, 10, 12, 15 and 16 illustrate example user interfaces displayed on a portable device of enabling a customer to access a customer account, locate and/or conduct transactions with advertisements on the system.

FIG. 14 is a schematic diagram of a generic computer system. Like reference symbols in the various drawings indicate like elements.

### DETAILED DESCRIPTION

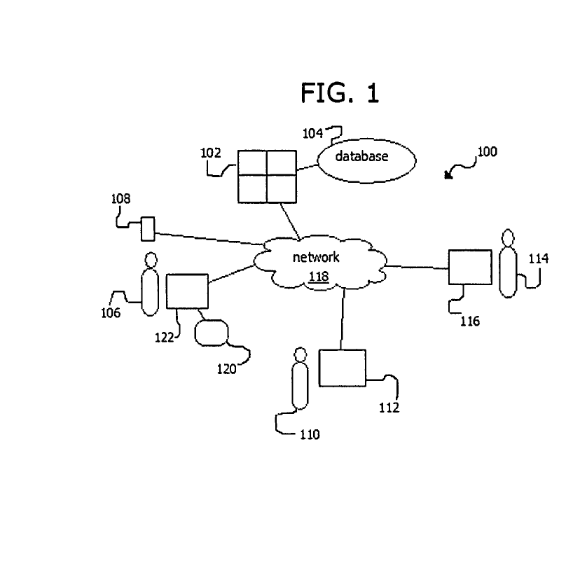

FIG. 1 illustrates an example system 100 for processing electronic transactions involving the creation, location, printing, purchase, reservation, and accounting of electronic savings advertisements. Electronic savings advertisements as used in this description means electronic scrip, electronic coupons, and/or electronic savings promotions. In general, scrip is a currency substitute that is not legal tender (a savings voucher or a gift certificate are good examples); electronic scrip is thus a paperless scrip that is delivered to an electronic display, e.g., a display of a personal computer (PC) or a portable device (such as a Smartphone or Tablet), rather than a hard copy. In general, a coupon is a ticket or document that can be exchanged for a discount or rebate when purchasing a product or service; an electronic coupon is thus a paperless coupon that may be delivered to an electronic display, e.g., a display of a PC or Portable Device, rather than a hard copy. In general, a savings promotion is a notice conveying news of a savings opportunity such as a promotional rate on a good or service, does not represent a binding agreement between a merchant and a customer, does not have a monetary value, and is only bound by the laws governing advertising in a particular geographic vicinity. An electronic savings promotion is thus a paperless notice conveying news of a promotional rate on a good or service that may be delivered to an electronic display, e.g., a display of a PC or Portable Device, rather than a hard copy. Electronic scrip, electronic coupons, and electronic savings promotions are referred to in this specification (Detailed Description) collectively as “savings advertisement(s)” or “electronic savings advertisement(s)”.

In the system 100, a server system 102 manages a database 104 which stores information for savings advertisements. The business manager 114 can use a merchant computing device 116 to access a user application providing interfaces that allow the business manager 114 to register a merchant account, create a landing page, and create an savings advertisement. An administrator 110 can update and maintain features of the system using an administration application displayed on an administrator computing device 112. A customer 106 can use a customer computing device 122 (such as a PC) or a portable device 108 to access a user application enabling a customer 106 to locate and conduct transactions with savings advertisements.

All of the application interfaces described in brief above can be, for example, accessed using a web browser on a business manager computing device 116, administrator computing device 112, customer computing device 122, or portable device 108, e.g., through a web page generated by the server system 102, or, in the case of a portable device 108, accessed using a dedicated application downloaded. The server system 102, customer computing device 122, portable device 108, administrator computing device 112, and business manager computing device 116 can communicate over a network 118. The network 118 can include, for example, one or more wired or wireless, public or private networks, such as the Internet.

The business manager 114, who can be a business owner or a person appointed to represent a business, can use the merchant computing device 116 to access a merchant account registration interface and create a merchant account. A merchant account registration interface can be, for example, accessed using a web browser on the merchant computing device 116 through a web page generated by the server system 102. The business manager 114 can provide business information that can be used to uniquely identify a merchant account and generate a merchant account credential. For example, the business manager 114 can provide a business name, business address, phone number, user name, password, email address, and EIN (Employer Identification Number). For businesses that have multiple locations (e.g., chain, franchise), the business manager 114 can provide, for example, for each location, a location address and phone number.

Information provided by the business manager 114 can be sent to the server system 102 and stored in the database 104 and associated with a unique business identifier that is automatically created by a server application on a server system 102. If the business has multiple locations, the business identifier can refer to a main business entity (e.g. corporation, main office) and a separate identifier can be created and associated with each location. Each location can be associated with a main entity (e.g. information for each location can be linked to a corresponding business in a database 104).

The system administrator 110 can use the system administrator computing device 112 to access a merchant account registration interface and create a merchant account. The merchant account registration interface can be, for example, accessed using a web browser on the system administrator computing device 112 through a web page generated by the server system 102.

The customer 106, can use the customer computing device 122 or portable device 108 to access a customer account registration interface and create a customer account. The customer account registration interface can be, for example, accessed using a web browser on the customer computing device 122 or portable device 108 through a web page generated by the server system 102 or by means of an application download to the portable device 108. The customer 106 can provide personal information that can be used to uniquely identify a customer account. For example, the customer 106 can provide a first name, last name, email address, and password and a unique identifier and account credential can be automatically created, such as by an application on the server system 102, and associated with a customer account.

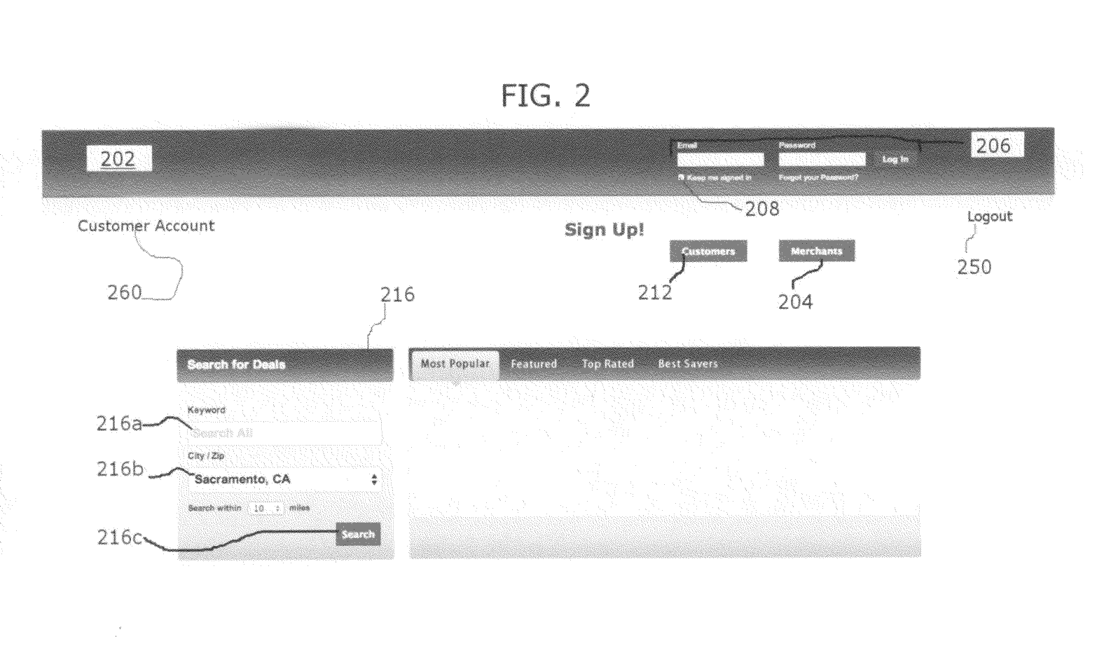

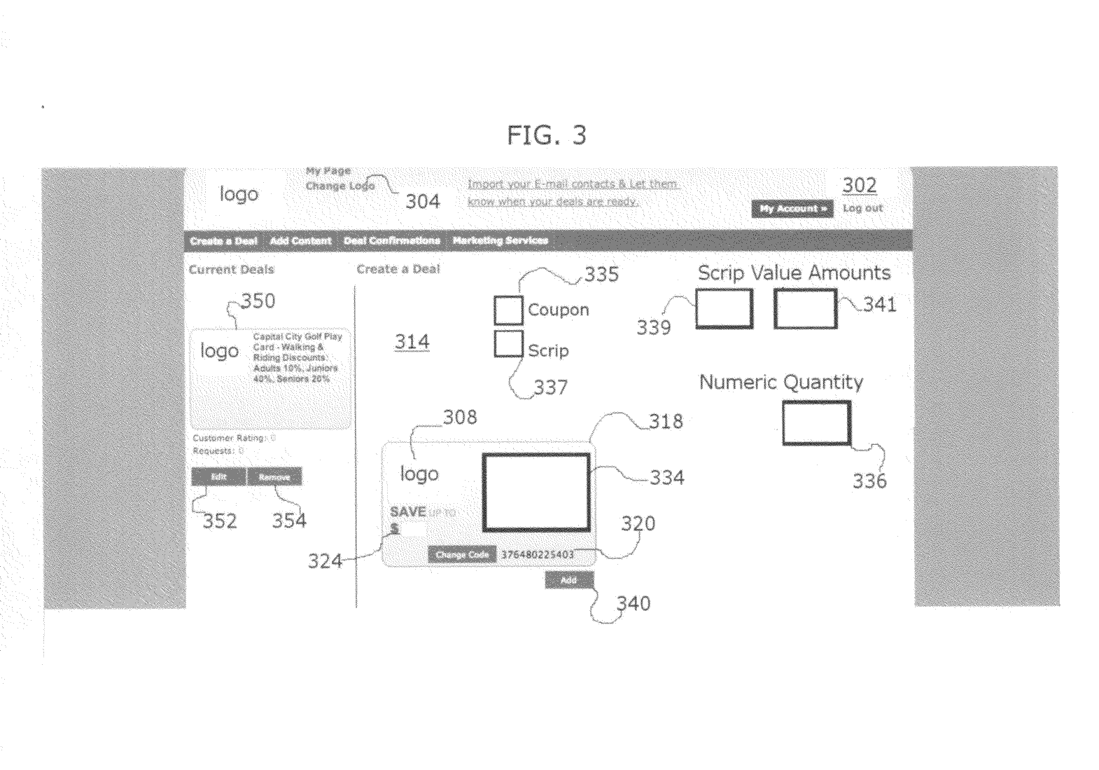

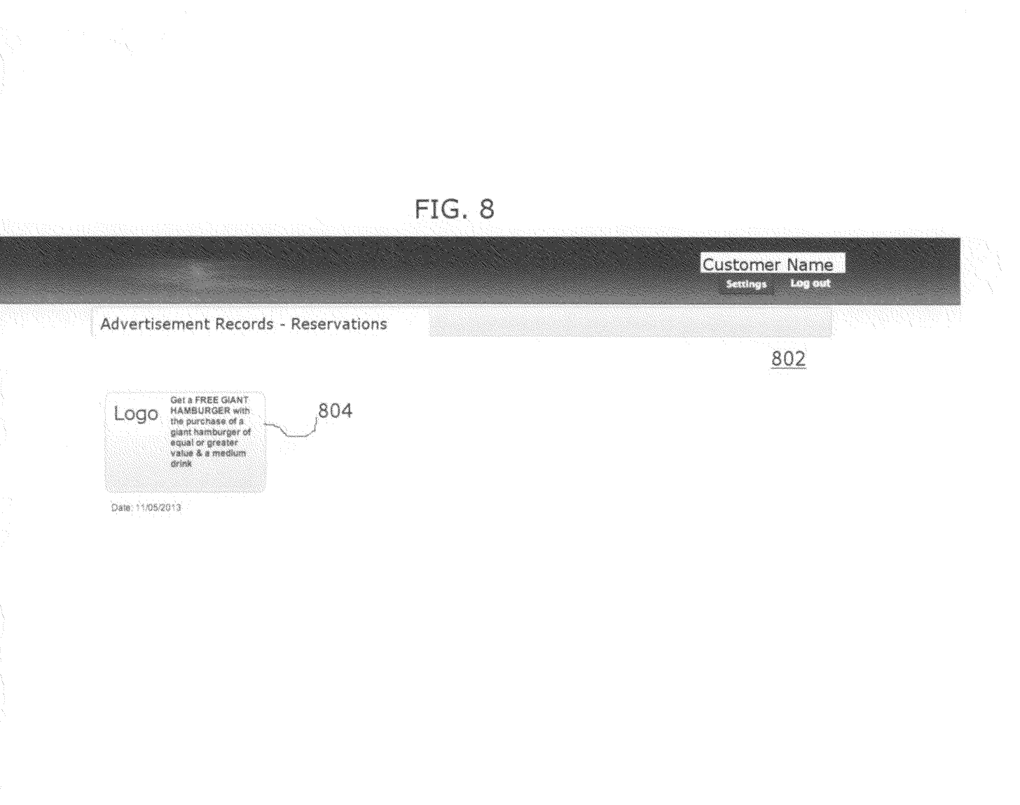

FIGS. 2 and 3 illustrates example user interfaces. Each of the example user interfaces illustrated in FIGS. 2 and 3 can be displayed, on the business manager computing device 116 or on the administrator computing device 112. FIGS. 2, 4, 5, and 8 illustrate example user interfaces. Each of the example user interfaces illustrated in FIGS. 2,4,5 and 8 can be displayed on the customer computing device 122. FIGS. 8 to 10, 12, 15, and 16 illustrates example user interfaces. Each of the example user interfaces illustrated in FIGS. 8 to 10, 12, 15, and 16 can be displayed on the portable device 108. Each of the example user interfaces illustrated in FIGS. 2 to 16 can be a web page including HTML (Hyper Text Markup Language) code and other resources generated by the server system 102 and delivered to the business manager computing device 116, administrator computing device 112, customer computing device 122, or portable device 108. The business manager computing device 116, administrator computing device 112, customer computing device 122, and portable device 108 can communicate with the server system 102 using, for example, Hypertext Transfer Protocol (HTTP).

FIG. 2 illustrates an example home page user interface 202. The home page user interface 202 can include a control 204 enabling a business manager to access a merchant account registration interface and register a merchant account. The home page interface 202 can include a login control 206 enabling a business manager to log into an existing merchant account. A business manager can select the control 204 on the home page user interface 202 and register a merchant account. A business manager can enter a credential into the login control 206 and access a merchant account user interface.

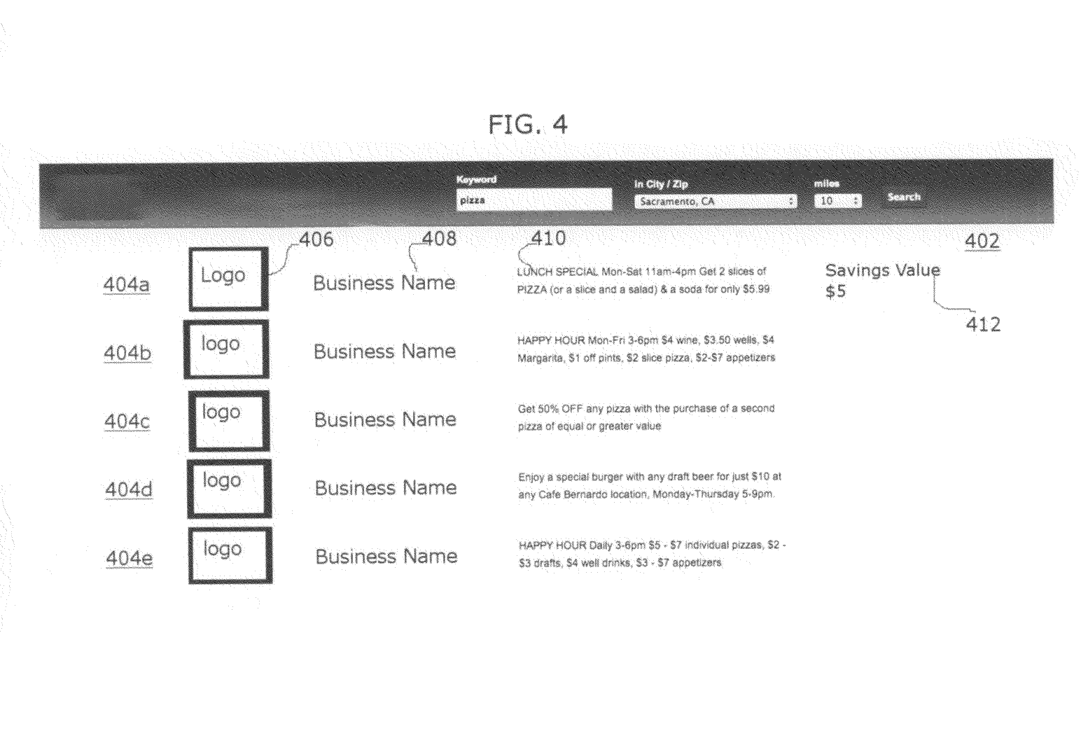

FIG. 3 illustrates a merchant account user interface 302. A business manager can create different types of savings advertisements using a merchant account user interface. For example, a business manager can display the merchant account user interface 302 on a business manager computing device by entering a login credential into a login control, for example, the login control 206 with respect to FIG. 2. A business manager can use the merchant account interface 302 to customize details of a landing page. For example, the merchant account user interface 302 can include a control 304 for displaying an interface to upload an image file for a logo. A business manager can integrate a logo into a landing page by selecting the control 304 and selecting an image file. A logo can be proportionately scaled and appear on various web pages of the system. For example, a logo can be automatically displayed on the merchant account user interface 302, on a landing page (for example, the landing page 802 with respect to FIG. 8A), on a template for creating a savings advertisement 308, in an image of a created savings advertisement 350, and in a search results interface (for example, the search results user interface 402 with respect to FIG. 4). In the case that a business manager does not upload an image file for a logo a business name provided during merchant account registration can be displayed in locations where a logo would otherwise be displayed. The control 304 can also be used to change a logo. For example, a business manager can select the control 304, and upload a different image file to change a logo.

The merchant account user interface 302 can include a savings advertisement creation user interface 314 for creating a savings advertisement. A business manager can use the savings advertisement creation interface 314 to create different types of savings advertisements. For example, the savings advertisement creation interface 314 can include a template 318 for creating a savings advertisement. A business manager can use the template 318 to create a savings advertisement to be featured on the system. The template 318 can include a business logo 308, a unique identifier 320, and a control 324 for associating with a savings advertisement a pecuniary value. A business manager can associate a pecuniary value with a savings advertisement by entering a number into the control 324. The template 318 can include a control 334 to add a savings advertisement description. A business manager can enter text into the control 334 to create a savings advertisement description.

The savings advertisement creation interface 314 can include controls 335 and 337 for associating a descriptions of terms defining a savings advertisement type. A description of terms defining a savings advertisement type can be displayed in association with a savings advertisement in the form of a message as text on the screen of a customer computing device, on a printed hard copy of a savings advertisement, or on the screen of a portable device. A description of terms displayed in association with a savings advertisement can distinguish a savings advertisement as an electronic savings promotion, an electronic coupon, or electronic scrip. For example, a business manager can select control 335 to associate with a savings advertisement a descriptions of terms identifying a savings advertisement is an electronic coupon. A business manager can select control 337 to associate with a savings advertisement a descriptions of terms identifying a savings advertisement as electronic scrip. As a default function of the system, a description of terms identifying a savings advertisement as a savings promotion can be automatically associated with each savings advertisement stored in the server database. A business manager can remove a default description of terms identifying a savings advertisement as a savings promotion by selecting the control 335 or the control 337.

A business manager can configure a savings advertisement as an electronic coupon. For example, a business manager can select the control 335 and enter a number into the contort 324 to associate a pecuniary value to identify a savings advertisement as an electronic coupon.

A business manager can configure a savings advertisement as electronic scrip. For example, the savings advertisement creation interface 314 can include a control 339 for associating with a savings advertisement a pecuniary purchase amount and a control 341 for associating pecuniary value amount with a savings advertisement. A business manager can select the control 337, enter a number in the control 339, and enter a number into the control 341 to configure a savings advertisement as electronic scrip. The number entered into the control 339 can be automatically restricted to a number lower than the number entered into the control 341 and a number entered into the control 341 can be restricted to number higher than a number entered into the control 339. The numbers entered into the controls 339 and 341 can be stored in association with a savings advertisement in the server database and represent pecuniary values, for example, displayed in a savings advertisement image with a message providing purchase and value details of a savings advertisement configured as electronic scrip, and, with respect to a purchase amount, during a transaction conducted to purchase a savings advertisement configured as electronic scrip. An application restriction can require a business manager to enter numbers into the controls 338 and 341 before finalizing the creation of a savings advertisement configured as electronic scrip (for example, when the control 337 is selected).

The savings advertisement creation interface 314 can include a control 336 for limiting the quantity of a savings advertisement. A business manager can limit the quantity of a savings advertisement by entering a numeric quantity into the control 336. A numeric quantity can be stored in the server database in association with a savings advertisement and can limit the number of transactions conducted with a savings advertisement by customers to acquire savings (described in greater detail below).

The savings advertisement creation interface 314 can include a control 340 for finalizing the creation of a savings advertisement. A business manager can select a control 340 to finalize the creation of a savings advertisement and store it in the server system database. A business manager can be prohibited by one or more application restrictions from finalizing the creation of a savings advertisement that is incomplete or invalid for displaying on the system. For example, automated warnings and descriptions can be provided to direct a business manager to the incomplete or invalid features of a savings advertisement. Upon finalizing the creation of a savings advertisement the savings advertisement can appear as a record, for example, in the form of a smaller image 350 displayed in the merchant account user interface 302.

The savings advertisement creation user interface 314 can include controls 352 and 354 enabling a business manager to edit and delete a savings advertisement. For example, a business manager can select control 352 to display the savings advertisement 350 in the savings advertisement creation interface 314 and make changes to the details of the savings advertisement 350, such as a change in the associated numeric quantity or configuration as a savings promotion, a coupon, or strip, and save the changes by selecting a control 340 to finalize an editing process. A business manager can delete a savings advertisement by selecting the control 354.

As mentioned, a system administrator can create and manage a merchant account and can create, edit, and delete a savings advertisement. Returning to FIG. 2, a system administrator (for example, the administrator 110 with respect to FIG. 1) can display the home page user interface 202 on an administrator computing device (for example, the computing device 112 with respect to FIG. 1). A system administrator can select the control 204 to display a registration form, enter business information, and create a merchant account. An administrator credential can be created and stored on the server system enabling a system administrator to log into an administrator panel interface and display a user interface for selecting a merchant and displaying a merchant account interface (for example, the merchant account user interface 302 with respect to FIG. 3). An administrator can enter an administrator credential into the control 206 and display an administrator panel interface on an administrator computing device.

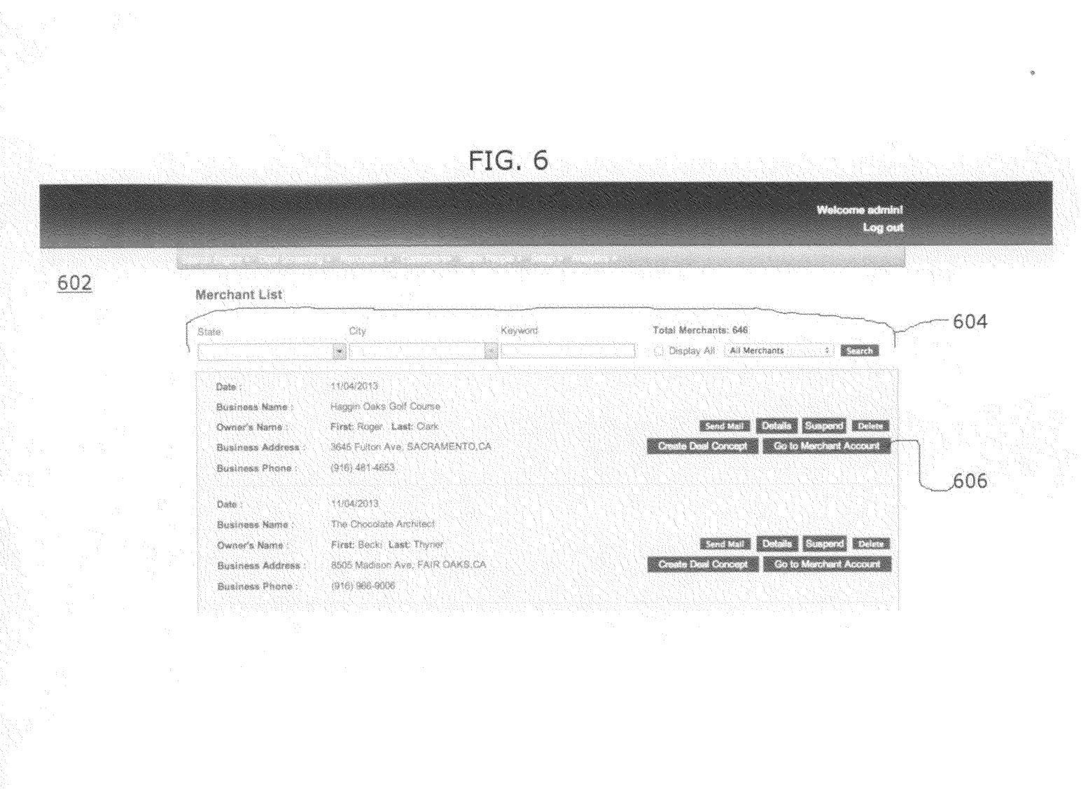

FIG. 6 illustrates an administrator panel interface 602. An administrator can display the administrator panel interface 602 on an administrator computing device by logging in using an administrator credential (for example, using the control 206 with respect to FIG. 2). The administrator panel interface can include search controls 604 for locating a merchant account on the system and a control 606 for displaying a merchant account interface associated with a merchant account. A control (for example, the control 606) can be included with each merchant account located in the administrator panel interface 602. An administrator can locate a merchant account on the system by entering terms, such as merchant information, and/or selecting options using the controls 604. An administrator can select the control 606 to display a merchant account user interface (for example, the merchant account user interface 302 with respect to FIG. 3) and make changes to a landing page and/or create, edit, or delete a savings advertisement.

Returning to FIG. 2, the home page user interface 202 can include a control 212 enabling a customer to display a customer account registration interface on a customer computing device and register a customer account. A customer can select the control 212 to access a customer account registration form and register a customer account on the system. A customer can log into an existing customer account by entering a login credential into the login control 206. The home page user interface 202 can include a control 208 enabling a customer to remain logged into a customer account. A customer can select the control 208 to remain logged into a customer account and the server can recognize the computing device used by a customer and automatically log the customer into a customer's customer account upon accessing a web page of the system, for example, the home page user interface 202. The home page user interface 202 can include a logout control 250. A customer can select the logout control 250 to log out of a customer account. The home page user interface 202 can include a control 260 for displaying a customer account interface. A customer can select the control 260 to display a customer account user interface while logged in.

A customer can locate a savings advertisement using the home page user interface 202. The home page user interface 202 can include a search engine 216 including a control 216a for entering search terms, a control 216b for selecting a geographic vicinity, for example, a designated radial distance around a city or a zip code, and a control 216c for initiating a search request. A customer can enter one or more search terms into the control 216a, select a geographic vicinity using the control 216b, and select the control 216c to initiate a search request and display savings advertisements matching search criteria in a search results user interface.

FIG. 4 illustrates a search results interface 402 displaying search results 404a-404e. The search results interface 402 can be displayed, for example, on a customer computing device in response to a search request conducted from a home page user interface (e.g., by selecting the control 216c with respect to FIG. 2). A search result 404 can include details of a savings advertisement. For example, a search result can include a business logo 406, a business name 408, a savings advertisement description 410, and, if provided, a pecuniary value 412 representing a savings amount. A customer can navigate a search results user interface 402 by scrolling. A customer can select a search result 404 to display a savings advertisement in a transaction interface.

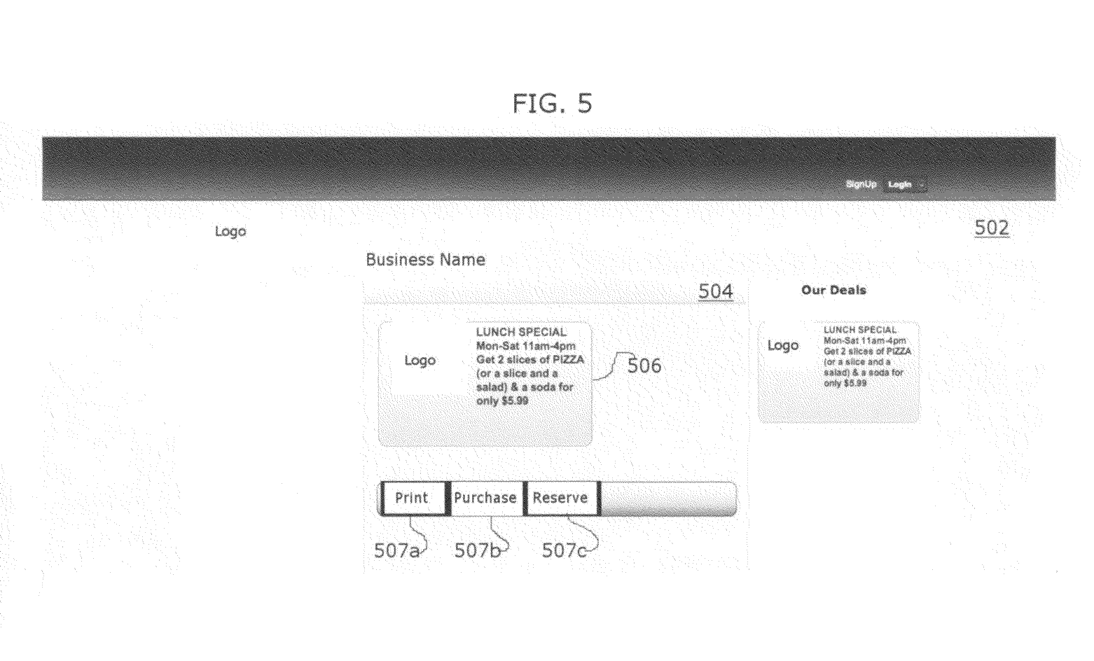

FIG. 5 illustrates an example landing page 502 of the system that includes a transaction interface 504 and an electronic savings advertisement 506. A customer can display the landing page 502, transaction interface 504, and savings advertisement 506 by selecting a search result from a search results interface (for example, any of the search results 404 with respect to FIG. 4).

A customer can use a transaction user interface of the system to conduct a transaction with a savings advertisement. For example, the transaction interface 504 can include controls 507a-507c for conducting transactions with the savings advertisement 506. A customer can select the control 507a to print a hard copy of the savings advertisement 506, which can be used by the customer to acquire savings during a future purchase. A customer can select the control 507b to purchase the savings advertisement 506 if the savings advertisement 506 is configured as a form of scrip. For example, a customer can select the control 507b to display a payment processing interface, enter payment information into the payment processing interface, and process a payment. Upon conducting a purchase a purchase record can be delivered to a customer and a customer can print or display the purchase record to acquire savings during a future purchase.

A customer can select the control 507c to reserve the savings advertisement 506. For example, a customer can select the control 507c to create an electronic record of the savings advertisement 506 and the electronic record can be stored in the server system database in association with the customer's customer account (described in greater detail below).

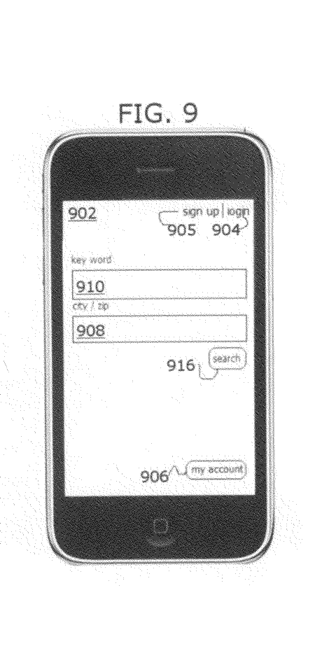

FIG. 9 illustrates a home page user interface 902 displayed on a portable device. The portable device can be, for example, the portable device 108 described above with respect to FIG. 1. The home page user interface 902 can include a control 905 for registering a customer account and a control 904 for displaying a customer account interface. A customer can select the control 905 to display a customer account registration form and register a customer account. A customer can select the control 904 to log into a customer account and display a customer account interface. The same control 904 can be used for a logout function. For example, the control 904 can display a “logout” message while a customer is logged in to a customer account and a customer can select the control 904 to log out of a customer account. The home page user interface 902 can include a control 906 for displaying a customer account interface.

A customer can locate a savings advertisement using a home page user interface on a portable device. For example, the home page user interface 902 can include a control 910 for entering search terms, a control 908 for selecting a geographic vicinity, such as a designated radial distance from a city name or zip code, and a control 916 for initiating a search. A customer can enter terms into the control 910, select a geographic vicinity using the control 908 and select the control 916 to display search results matching search criteria in a search results user interface.

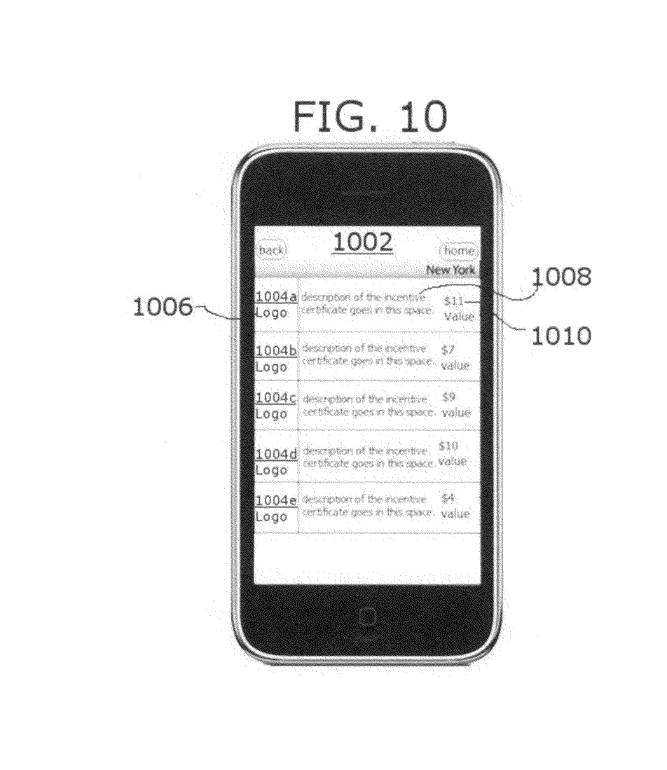

FIG. 10 illustrates a search results user interface 1002 displaying search results 1004a-1004e on a portable device. A customer can locate savings advertisements on a search results interface using a portable device. For example, the search results interface 1002 can be displayed, for example, in response to a search conducted for a savings advertisement on a home page user interface (for example, the home page user interface 1002 with respect to FIG. 10). A search result displayed in the search results interface 1002 can include a business logo 1006, an offer description 1008, and, if provided, a pecuniary value 1010 representing a savings amount. A customer can navigate the search results user interface 1002 by scrolling down, for example, using a touchscreen. A customer can select each of the search results 1004 located in the search results interface 1002 to display a landing page with an savings advertisement in a transaction user interface.

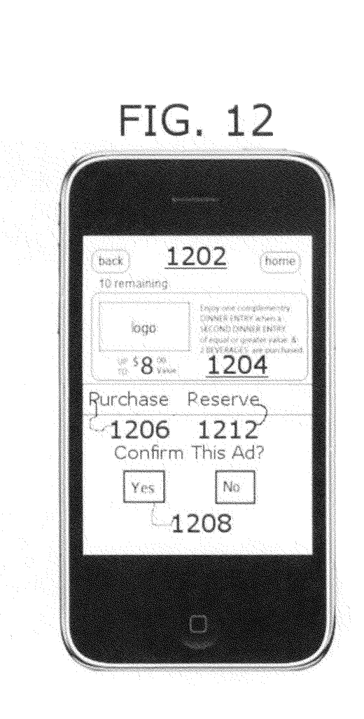

FIG. 12 illustrates a transaction user interface 1202 that includes a savings advertisement 1204 on a portable device. A customer can conduct a transaction with a savings advertisement using a portable device. For example, a customer can display the savings advertisement 1204 in the transaction interface 1202 by selecting a search result from a search results interface (for example, by selecting any of the search results 1004 with respect to FIG. 10).

The transaction user interface 1202 can include controls 1206, 1212 and 1208 enabling a customer to conduct a transaction with the savings advertisement 1204. A customer can select the control 1208 to confirm the use of the savings advertisement 1204, for example, to acquire savings during a purchase at a point of sale. A customer can select a control 1206 to purchase the savings advertisement 1204 if the savings advertisement 1204 has been configured as a form of scrip. For example, a customer can select the control 1206 to display a payment processing interface, enter payment information, and process a payment to purchase the savings advertisement 1204. An electronic record of purchase can be delivered to the customer and a customer can print or display the electronic record of purchase to acquire savings during a purchase at a point of sale or during a future purchase. A customer can select the control 1212 to reserve the savings advertisement 1204. For example, a customer can select the control 1212 to create an electronic record of the savings advertisement 1204 and the electronic record can be stored in the server system database in association with the customer's customer account (described in greater detail below).

As described, a customer can, using a customer computing device or a portable device, conduct a transaction to reserve an electronic savings advertisement. A customer can, for example, be required to log into a customer account before conducting a transaction to reserve a savings advertisement. While logged into a customer account a customer can select a control (for example, control 507c with respect to FIG. 5 or control 1212 with respect to FIG. 12) to create an electronic record of a savings advertisement (for example, savings advertisement 506 with respect to FIG. 5 or savings advertisement 1204 with respect to FIG. 12) and an electronic savings advertisement record can be stored in the server system database in association with the customer's customer account. While logged into a customer account, a customer can display a customer account user interface. For example, a customer can display a customer account interface on a customer computing device by selecting the control 260 with respect to FIG. 2.

FIG. 8 illustrates a customer account user interface 802 displayed on a customer computing device. The customer account user interface 802 can include an electronic savings advertisement record 804. A customer can display the customer account user interface 802 and the savings advertisement record 804 by selecting a control (for example, the control 260 with respect to FIG. 2) while a customer is logged into a customer account. A customer can select the savings advertisement record 804 to display the savings advertisement record 804 in a transaction user interface enabling the customer to conduct a transaction with the savings advertisement record 804.

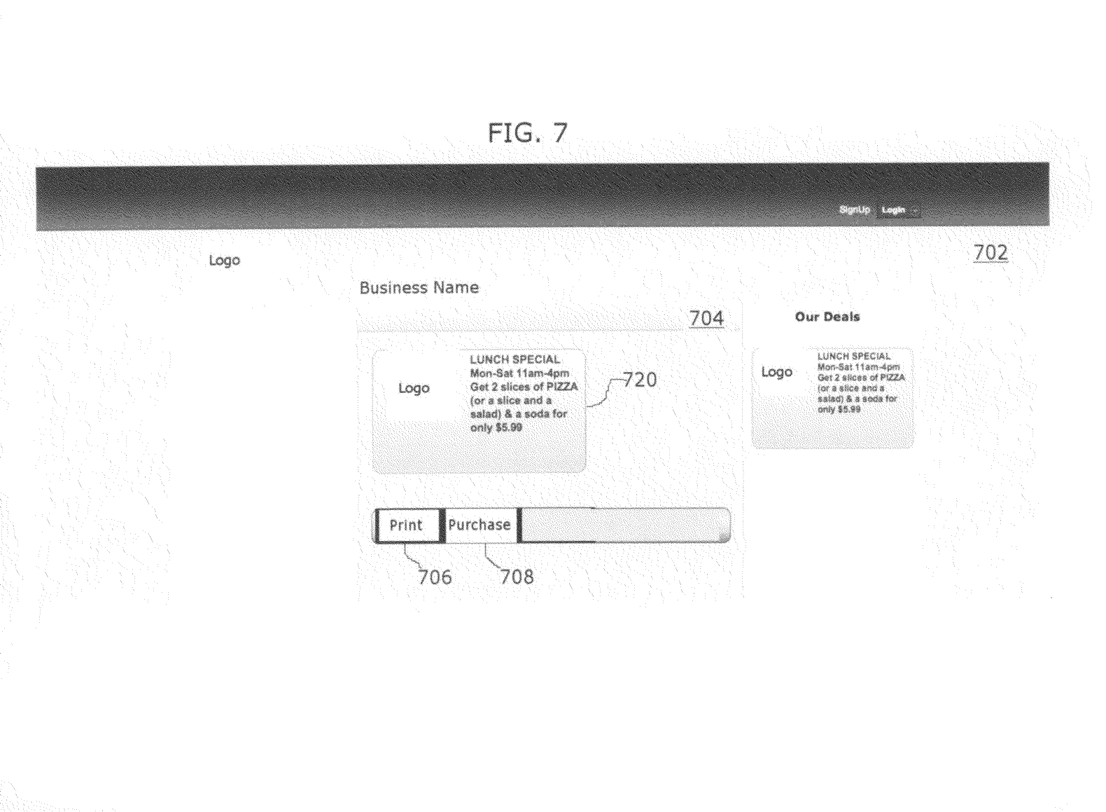

FIG. 7 illustrates an electronic savings advertisement record 720 displayed in a transaction interface 702 on a customer computing device. A customer can conduct a transaction with a savings advertisement record displayed on a customer computing device. For example, the savings advertisement record 720 and the transaction interface 702 can be displayed in response to the selection of an savings advertisement record in a customer account user interface (for example, the savings advertisement record 804 displayed in the customer account interface 802). The transaction interface 702 can include controls 706 and 708 for conducting a transaction with the electronic savings advertisement record 720. A customer can select the control 706 to print a hard copy of the savings advertisement record 720, which can be used by the customer to acquire savings during a future purchase. A customer can select the control 708 to purchase the savings advertisement record 720 if the savings advertisement from which the savings advertisement record was created is configured as a form of scrip. For example, a customer can select the control 708 to display a payment processing interface, enter payment information into the payment processing interface, and process a payment. Upon conducting a purchase a purchase record can be delivered to a customer and a customer can print or display the purchase record (for example, on a portable device) to acquire savings during a future purchase.

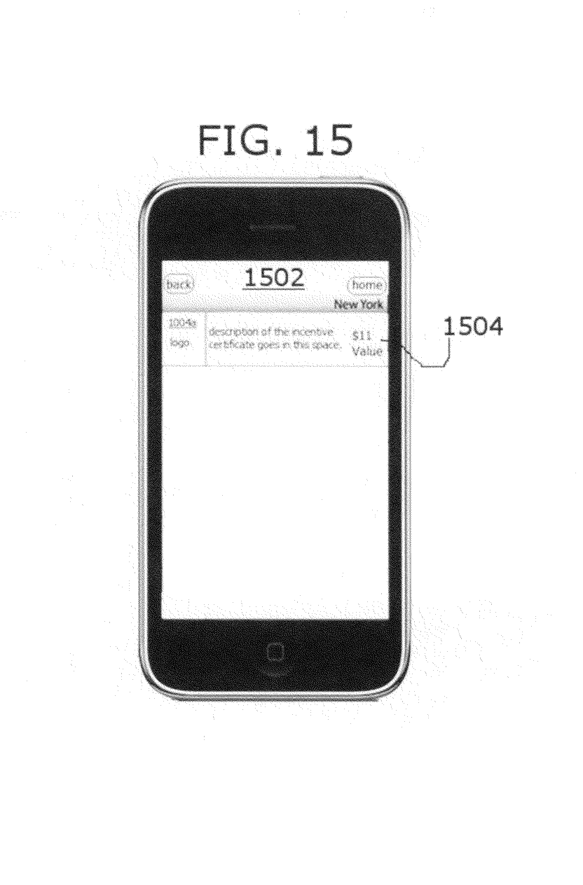

FIG. 15 illustrates a customer account user interface 1502 displayed on a portable device. The customer account user interface 1502 includes an electronic savings advertisement record 1504. A customer can display the customer account user interface 1502 and the savings advertisement record 1504 by selecting a control (for example, the control 906 with respect to FIG. 9) while a customer is logged into a customer account. A customer can select the savings advertisement record 1504 to display the savings advertisement record 1504 in a transaction user interface enabling the customer to conduct a transaction with the savings advertisement record 1504.

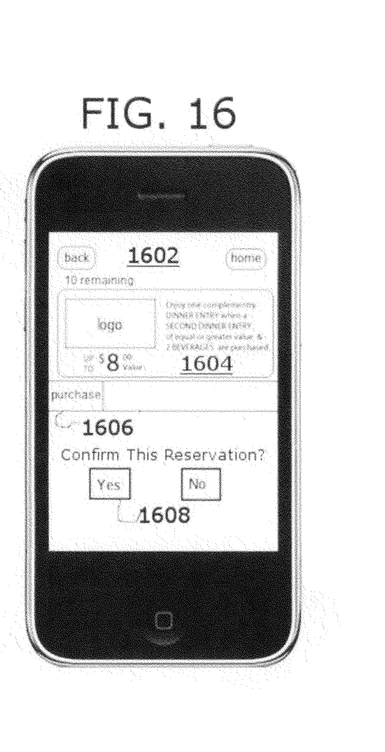

FIG. 16 illustrates an electronic savings advertisement record 1604 displayed in a transaction interface 1602 on a portable device. A customer can conduct a transaction with a savings advertisement record using a portable device. The savings advertisement record 1604 and the transaction interface 1602 can be displayed in response to the selection of a savings advertisement record in a customer account user interface (for example, the savings advertisement record 1504 displayed in the customer account interface 1502). The transaction interface 1602 displaying the savings advertisement record 1604 can include controls 1606 and 1608 for conducting a transaction with the savings advertisement record 1604. A customer can select the control 1608 to confirm the use of the savings advertisement record 1604, for example, to acquire savings during a purchase at a point of sale. A customer can select a control 1606 to purchase the savings advertisement record 1604 if the savings advertisement from which the savings advertisement record 1604 was created is configured as a form of scrip. For example, a customer can select the control 1606 to display a payment processing interface, enter payment information, and process a payment to purchase the savings advertisement record 1604. An electronic record of purchase can be delivered to the customer and a customer can print or display the electronic record of purchase to acquire savings during a purchase at a point of sale or during a future purchase.

A savings advertisement record can be restricted to a number of transactions. For example, a savings advertisement record can be removed from a customer account interface after a transaction has been conducted with it.

As described, a customer can display a savings advertisement in a transaction interface (for example, the transaction interface 502 with respect to FIG. 5 or transaction interface 1202 with respect to FIG. 12) and conduct a transaction with a savings advertisement. Each transaction conducted with a savings advertisement by a customer using a customer computing device (for example, the savings advertisement 506 with respect to FIG. 5) can cause a reduction in the numeric quantity associated with a savings advertisement. For example, a customer can select a control to print, purchase, or reserve a savings advertisement (controls 507a, 507b, and 507c respectively and savings advertisement 506 with respect to FIG. 5) and each transaction can cause the numeric quantity associated with a savings advertisement (for example, the savings advertisement 506 with respect to FIG. 5) to be decremented by a factor of one per transaction.

Each transaction conducted with a savings advertisement by a customer using a portable device (for example, the savings advertisement 1204 with respect to FIG. 4) can cause a reduction in the numeric quantity associated with a savings advertisement. For example, a customer can select a control to purchase, confirm, or reserve a savings advertisement (controls 1206, 1208, and 1212 respectively and savings advertisement 1204 with respect to FIG. 12) and each transaction can cause the numeric quantity associated with a savings advertisement (for example, the savings advertisement 1204 with respect to FIG. 12) to be decremented by a factor of one per transaction. A customer can be restricted from conducting a transaction with a savings advertisement having an associated numeric quantity of zero.

In an alternative embodiment, a time limit can be associated with a savings advertisement record when a customer conducts a transaction to reserve a savings advertisement. A savings advertisement record can be removed from a customer account interface and the numeric quantity associated with a savings advertisement can be incremented after a time limit elapses.

In an alternative embodiment an increased degree of accuracy of accounting for transactions conducted with an electronic savings advertisement can be provided. A customer can be required to log into a customer account before conducting a transaction with a savings advertisement and a customer can be restricted to making a specified number of transactions per each savings advertisement. For example, a customer can be restricted to one transaction per savings advertisement.

A number of embodiments of the invention have been described. Nevertheless, it will be understood that various modifications can be made without departing from the spirit and scope of the invention. For example, various forms of the flows shown above can be used, with steps re-ordered, added, or removed. Home and back controls can be provided on all or some of the web pages of the system to facilitate or enhance the navigation of web pages. Also, it should be recognized that numerous applications are contemplated for validating electronic scrip and processing payments. For example, either an online system or phone system can be provided for validating the unique ID of a form of scrip or a coupon and numeric IDs can be validated by entering numbers into a phone or into a web page in an online system of validating a savings advertisement ID. Revenue can be appropriated in a variety of ways according to the validations of electronic scrip IDs. For example, a pecuniary value associated with electronic scrip as a purchase amount can be accounted for when validated and added to represent a total amount to be paid to a merchant. A check can be processed for payment and sent to the merchant and the total amount can be changed to zero after funds have been paid. The invention depicted herein is not limited to any specific system of validating the authenticity of a savings advertisement or transferring pecuniary amounts owed to merchants for electronic scrip purchases.

The numeric quantity associated with a savings advertisement can be displayed for customers and/or merchants. For example, the numeric quantity associated with a savings advertisement can be displayed in association with a savings advertisement image on the system, on any or all of the interfaces used for creating, locating, or otherwise displaying a savings advertisement, and the numeric quantity displayed can update when a web page of the system is refreshed.

A record of purchase of electronic scrip can be delivered to a customer in a variety of ways. For example, a record of purchase can be emailed to a customer, sent as a text message to customers portable device, or provided on the system, for example, in a folder of a customer account, and displayed by a customer when displaying a customer account on a customer computing device or portable device.

A customer account interface can include additional folders for displaying savings advertisements according to customer interests or savings advertisement categories. For example, a transaction interface displayed on a customer computing device or portable device can include a control enabling a customer to select a savings advertisement as a favorite and a record of a savings advertisement selected as a favorite can be delivered to a folder in a customer account. A customer can display a customer account interface, select a folder that includes savings advertisements marked as favorites, select a savings advertisement record displayed in the folder, display a savings advertisement in a transaction interface, and conduct a transaction with a savings advertisement.

A wait list program can be provided enabling a customer to deliver a request for a savings advertisement to a merchant and receive an automatically generated reservation for a requested savings advertisement. For example, a savings advertisement can remain on the system after a numeric quantity associated with a savings advertisement has reached zero and a savings advertisement's associated numeric quantity can be displayed on a user interface for locating savings advertisements. A control can be provided for conducting a request transaction and displayed directly below a savings advertisement having an associated numeric quantity of zero. A customer can log into a customer account and select the request control and a merchant can receive a request for a savings advertisement, for example, in a savings advertisement creation user interface. In response to a request transactions a customer account ID can be stored in a list on the server database according to the time the request was conducted, from first to last. A business manager can increase the numeric quantity associated with the savings advertisement (for example, during an edit process) and a savings advertisement record can be automatically sent to each of the customer accounts having a unique ID stored in a request list in the order in which a customer account is positioned. A message, such as an email or text message delivered to a mobile phone, can be sent notifying a customer that a savings advertisement record has been created and delivered to the customer's customer account.

Additional controls and user interfaces can be provided to enhance a merchant landing page. For example, a merchant profile can be included in a landing page and user interfaces can be provided on a merchant account interface for creating and/or uploading content to customize or enhance a merchant profile.

A savings advertisement displayed on web pages of the system can be configured to be used in one or more systems of social media enabling a customer to share a savings advertisement using the Internet and/or a text messaging system of a portable device.

A savings advertisement creation interface can include one or more controls for designating delivery options in association with a savings advertisement. For example, controls can be included in a savings advertisement creation interface to restrict the delivery of a savings advertisement to portable devices or to computing devices. A business manager can select controls to allow for one or both delivery options.

The system can include one or more controls for associating restrictions with an savings advertisement. For example, additional controls can be included in an savings advertisement creation interface and a business manager can select controls to restrict the use of a savings advertisement by means of: prohibiting use of a savings advertisement during certain days of the week; prohibiting use of a savings advertisement during certain times of the day; prohibiting use of a savings advertisement during major holidays of the calendar year; prohibiting use of a savings advertisement at nonparticipating business locations; prohibiting use of a savings advertisement after a date of expiration; prohibiting the number of uses of a savings advertisement per customer account; prohibiting the use of a savings advertisement during specific durations of time; prohibiting the combination of a savings advertisement with other deals or offers; prohibiting the use of a savings advertisement to the availability of a product or service; prohibiting the use of a savings advertisement according to terms typed into a control in the form of a description. A customer can be automatically restricted from conducting a transaction with a savings advertisements having restrictions, such as day, time, or frequency of use restrictions. For example, a customer can be required to log in to a customer account before conducting a transaction with a savings advertisement having associated restrictions and the controls of a transaction user interface can be rendered inactive as per restriction criteria.

The controls for conducting a transaction with a savings advertisement can be restricted according to other specifications made by a business manager when creating a savings advertisement. For example, a control for printing a savings advertisement can be automatically rendered inactive for a savings advertisement that has been restricted to portable devices. A control for conducting a reservation transaction can be automatically rendered inactive for a savings advertisement not having an associated numeric quantity. A control for conducting a purchase transaction can be automatically rendered inactive for a savings advertisement that is not configured as electronic scrip.

The system can be configured to receive and respond to audio commands. A customer or a business manager can navigate web pages and use user interfaces of the system to locate as well as conduct transactions with savings advertisements using audio commands.

Savings advertisements can be located on the system in a variety of ways. For example, categorical lists of savings advertisements can be manually created or automatically generated by a server application and displayed in a home page user interface of the system. A customer can select a categorical list, select a savings advertisement displayed in a list to display the savings advertisement in a transaction interface, and conduct a transaction with the savings advertisement.

A savings advertisement creation interface can include text samples that can be organized by marketing schemes that are popular in the market and can include controls for selecting a text sample and displaying it on a template included in the savings advertisement creation interface. A business manager can select a text sample to include it on an a savings advertisement template.

A savings advertisement creation user interface can include one or more controls for associating a bar code or a quadratic residue (QR) code with a savings advertisement. For example, a control can be provided on a savings advertisement creation interface providing one or more bar code and/or QR code symbologies. A business manager or system administrator can select a bar code symbology (for example, code 39, code 128, Codabar, Postnet, etc.) or QR code symbology and bar code or QR code can be randomly generated and associated with a savings advertisement. A user interface for locating a savings advertisement can include a control for displaying a bar code or QR code associated with a savings advertisement. For example, a control for displaying a bar code or QR code can be provided on or directly below a savings advertisement image as it is displayed on web pages of the system, and the bar code or QR code associated with a savings advertisement can be displayed when the control is selected. The system can be configured to print a bar code or QR code with a savings advertisement in a printed hard copy.

A savings advertisement creation user interface can include one or more controls for associating one or more hyperlinks with a savings advertisement. For example, a control can be provided on an advertisement creation interface of the system. A business manager or system administrator can enter a hyperlink URL into a control to associate a hyperlink with a savings advertisement. A user interface for locating a savings advertisement can include a control for displaying a hyperlink associated with a savings advertisement. For example, a control for displaying a hyperlink can be provided on or directly below a savings advertisement image as it is displayed on web pages of the system, and the hyperlink associated with a savings advertisement can be displayed when the control is selected. The system can be configured to decrement an associated numeric quantity by a factor of one each time a hyperlink is selected.

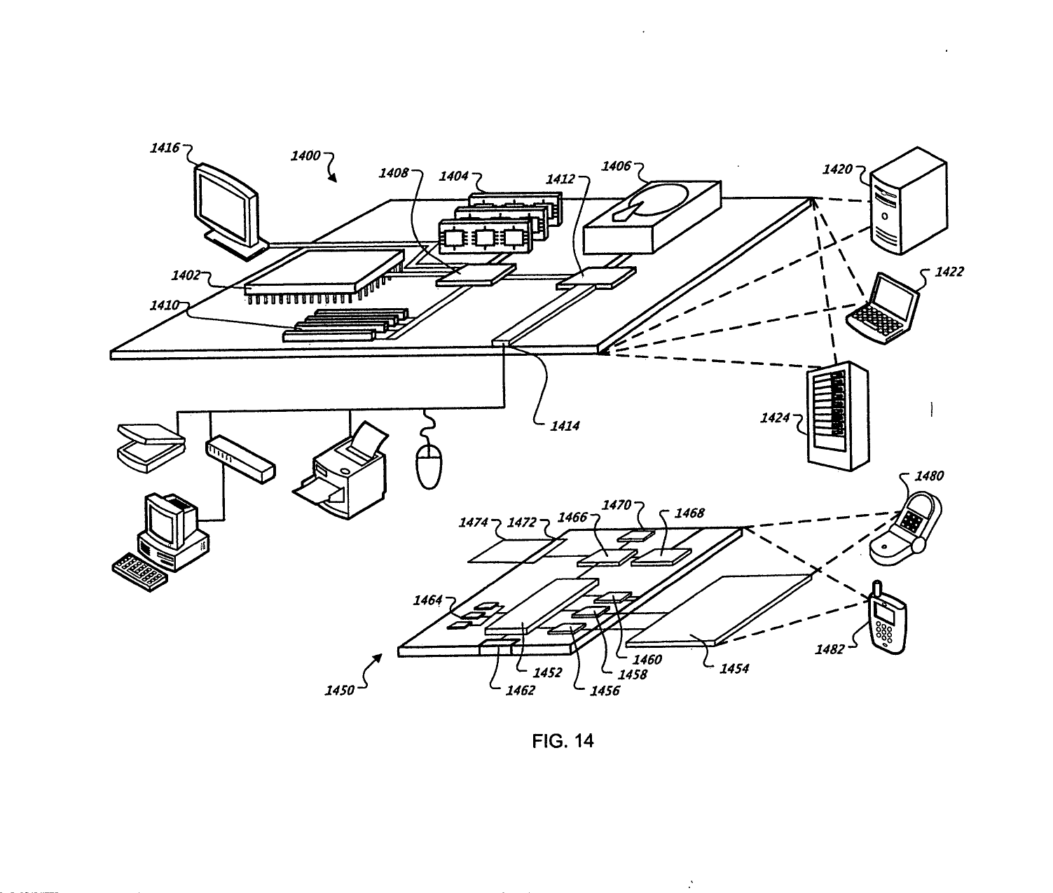

FIG. 14 is a block diagram of computing devices 1400, 1450 that can be used to implement the systems and methods described in this document, as either a client or as a server or plurality of servers. Computing device 1400 is intended to represent various forms of digital computers, such as laptops, desktops, workstations, personal digital assistants, servers, blade servers, mainframes, and other appropriate computers. Computing device 1450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412, are interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple buses can be used, as appropriate, along with multiple memories and types of memory. Also, multiple computing devices 1400 can be connected, with each device providing portions of the necessary operations (e.g., as a server bank, a group of blade servers, or a multiprocessor system).

The memory 1404 stores information within the computing device 1400. In one implementation, the memory 1404 is a computer-readable medium. In one implementation, the memory 1404 is a volatile memory unit or units. In some implementations, the memory 1404 is a non-volatile memory unit or units.

The storage device 1406 is capable of providing mass storage for the computing device 1400. In one implementation, the storage device 1406 is a computer-readable medium. In various different implementations, the storage device 1406 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1404, the storage device 1406, or memory on processor 1402.

The high speed controller 1408 manages bandwidth-intensive operations for the computing device 1400, while the low speed controller 1412 manages lower bandwidth intensive operations. Such allocation of duties is exemplary only. In one implementation, the high-speed controller 1408 is coupled to memory 1404, display 1416 (e.g., through a graphics processor or accelerator), and to high-speed expansion ports 1410, which can accept various expansion cards (not shown). In the implementation, low-speed controller 1412 is coupled to storage device 1406 and low-speed expansion port 1414. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1400 can be implemented in a number of different forms, as shown in the figure. For example, it can be implemented as a standard server 1420, or multiple times in a group of such servers. It can also be implemented as part of a rack server system 1424. In addition, it can be implemented in a personal computer such as a laptop computer 1422. Alternatively, components from computing device 1400 can be combined with other components in a mobile device (not shown), such as device 1450. Each of such devices can contain one or more of computing device 1400, 1450, and an entire system can be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 can also be provided with a storage device, such as a microdrive or other device, to provide additional storage. Each of the components 1450, 1452, 1464, 1454, 1466, and 1468, are interconnected using various buses, and several of the components can be mounted on a common motherboard or in other manners as appropriate.

The processor 1452 can process instructions for execution within the computing device 1450, including instructions stored in the memory 1464. The processor can also include separate analog and digital processors. The processor can provide, for example, for coordination of the other components of the device 1450, such as control of user interfaces, applications run by device 1450, and wireless communication by device 1450.

Processor 1452 can communicate with a user through control interface 1458 and display interface 1456 coupled to a display 1454. The display 1454 can be, for example, a TFT LCD display or an OLED display, or other appropriate display technology. The display interface 1456 can comprise appropriate circuitry for driving the display 1454 to present graphical and other information to a user. The control interface 1458 can receive commands from a user and convert them for submission to the processor 1452. In addition, an external interface 1462 can be provide in communication with processor 1452, so as to enable near area communication of device 1450 with other devices. External interface 1462 can provide, for example, for wired communication (e.g., via a docking procedure) or for wireless communication (e.g., via Bluetooth or other such technologies).

The memory 1464 stores information within the computing device 1450. In one implementation, the memory 1464 is a computer-readable medium. In one implementation, the memory 1464 is a volatile memory unit or units. In another implementation, the memory 1464 is a non-volatile memory unit or units. Expansion memory 1474 can also be provided and connected to device 1450 through expansion interface 1472, which can include, for example, a SIMM card interface. Such expansion memory 1474 can provide extra storage space for device 1450, or can also store applications or other information for device 1450. Specifically, expansion memory 1474 can include instructions to carry out or supplement the processes described above, and can include secure information also. Thus, for example, expansion memory 1474 can be provided as a security module for device 1450, and can be programmed with instructions that permit secure use of device 1450. In addition, secure applications can be provided via the SIMM cards, along with additional information, such as placing identifying information on the SIMM card in a non-hackable manner.

The memory can include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, or memory on processor 1452.

Device 1450 can communicate wirelessly through communication interface 1466, which can include digital signal processing circuitry where necessary. Communication interface 1466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 1468. In addition, short-range communication can occur, such as using a Bluetooth, WiFi, or other such transceiver (not shown). In addition, GPS receiver module 1470 can provide additional wireless data to device 1450, which can be used as appropriate by applications running on device 1450.

Device 1450 can also communication audibly using audio codec 1460, which can receive spoken information from a user and convert it to usable digital information. Audio codex 1460 can likewise generate audible sound for a user, such as through a speaker, e.g., in a handset of device 1450. Such sound can include sound from voice telephone calls, can include recorded sound (e.g., voice messages, music files, etc.) and can also include sound generated by applications operating on device 1450.

The computing device 1450 can be implemented in a number of different forms, as shown in the figure. For example, it can be implemented as a cellular telephone 1480. It can also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications can be made without departing from the spirit and scope of the invention. For example, various forms of the flows shown above can be used, with steps re-ordered, added, or removed. Also, although several applications of the payment systems and methods have been described, it should be recognized that numerous other applications are contemplated. Accordingly, other embodiments are within the scope of the following claims.

Accordingly, other embodiments are within the scope of the following claims:

What is claimed is:

1. A method of reserving an electronic savings advertisement comprising:
delivering an electronic savings advertisement creation interface web page from a server system to a computer system of a merchant;
receiving at the server system a request from the computer system of the merchant to generate an electronic savings advertisement, the request comprising a maximum number of transactions that can be conducted with the electronic savings advertisement;
storing in the server system a value representing an available numeric quantity for the savings advertisement;
determining in the server system whether the numeric quantity is greater than zero;
delivering an electronic savings advertisement request interface web page from the server system to a computer system of a customer, the savings advertisement request interface web page including an offer for the savings advertisement;
receiving at the computer system of the customer a reservation request for the electronic savings advertisement; and decrementing the available numeric quantity by one in the server system in response to the reservation request.

2. The method of claim 1, further comprising restricting another customer from making a reservation request for the savings advertisement if the available numeric quantity is zero.

3. The method of claim 1, further comprising providing on the server system means for uniquely identifying a customer while using the electronic savings advertisement request interface web page;
providing on the electronic savings advertisement creation interface web page means for associating with an electronic savings advertisement restrictions criteria;
receiving at the server system a request from the computer system of the merchant or the computer system of the administrator to generate an electronic savings advertisement, the request comprising restrictions criteria; and
providing on the electronic savings advertisement transaction interface web page means for automatically restricting the number of reservation requests conducted for the savings advertisement according to the associated restrictions criteria.

4. The method of claim 1, further comprising storing a maximum transaction time, determining whether the maximum transaction time has passed from the time of the reservation request without the electronic savings advertisement request being used by the customer, and incrementing the available numeric quantity by one in the server system.

5. The method of claim 1, further comprising delivering an electronic savings advertisement transaction interface web page from the server system to the computer system of the customer, the savings advertisement transaction interface web page including an offer for the savings advertisement and means for conducting a transaction with the savings advertisement enabling a customer to save money on a good or service either during a purchase at a point of sale or during a future purchase; and
decrementing the available numeric quantity by one in the server system in response to the transaction enabling a customer to save money on a good or service.

6. The method of claim 5, further comprising uniquely identifying a customer while using the electronic savings advertisement transaction interface web page;
providing on the electronic savings advertisement creation interface web page means for associating with an electronic savings advertisement restrictions criteria;
receiving at the server system a request from the computer system of the merchant or the computer system of the administrator to generate an electronic savings advertisement, the request comprising restrictions criteria; and
providing on the electronic savings advertisement transaction interface web page means for automatically restricting the number of transactions conducted with the savings advertisement enabling a customer to receive a promotional rate on a good or service according to the restrictions criteria.

7. The method of claim 1, further comprising delivering an electronic savings advertisement transaction interface web page from the server system to a portable web-enabled device of the customer, the savings advertisement transaction interface web page including an offer for the savings advertisement and means for receiving at the portable device of the customer a reservation request for the electronic savings advertisement; and
decrementing the available numeric quantity by one in the server system in response to the reservation request.

8. The method of claim 7, further comprising providing in the electronic savings advertisement transaction interface web page means for conducting a transaction with the savings advertisement enabling a customer to save money on a good or service either during a purchase at a point of sale or during a future purchase; and
decrementing the available numeric quantity by one in the server system in response to the transaction conducted with the savings advertisement enabling a customer to save money on a good or service.

9. A method of reserving an electronic savings advertisement comprising:
delivering an electronic savings advertisement creation interface web page from a server system to a computer system of an administrator;
receiving at the server system a request from the computer system of the administrator to generate an electronic savings advertisement, the request comprising a maximum number of transactions that can be conducted with the electronic savings advertisement;
storing in the server system a value representing an available numeric quantity for the savings advertisement;
determining in the server system whether the numeric quantity is greater than zero;
delivering an electronic savings advertisement request interface web page from the server system to a computer system of a customer, the savings advertisement request interface web page including an offer for the savings advertisement;
receiving at the computer system of the customer a reservation request for the electronic savings advertisement; and decrementing the available numeric quantity by one in the server system in response to the reservation request.

10. The method of claim 9, further comprising restricting another customer from making a reservation request for the savings advertisement if the available numeric quantity is zero.

11. The method of claim 9, further comprising providing on the server system means for uniquely identifying a customer while using the electronic savings advertisement request interface web page;
providing on the electronic savings advertisement creation interface web page means for associating with an electronic savings advertisement restrictions criteria;
receiving at the server system a request from the computer system of the merchant or the computer system of the administrator to generate an electronic savings advertisement, the request comprising restrictions criteria; and
providing on the electronic savings advertisement transaction interface web page means for automatically restricting the number of reservation requests conducted for the savings advertisement to the associated restrictions criteria.

12. The method of claim 9, further comprising storing a maximum transaction time, determining whether the maximum transaction time has passed from the time of the reservation request without the electronic savings advertisement request being used by the customer, and incrementing the available numeric quantity by one in the server system.

13. The method of claim 9, further comprising delivering an electronic savings advertisement transaction interface web page from the server system to the computer system of the customer, the savings advertisement transaction interface web page including an offer for the savings advertisement and means for conducting a transaction with the savings advertisement enabling a customer to receive a promotional rate on a good or service either during a purchase at a point of sale or during a future purchase; and
decrementing the available numeric quantity by one in the server system in response to the transaction enabling a customer to receive a promotional rate on a good or service.

14. The method of claim 13, further comprising uniquely identifying a customer while using the electronic savings advertisement transaction interface web page;
providing on the electronic savings advertisement creation interface web page means for associating with an electronic savings advertisement restrictions criteria;
receiving at the server system a request from the computer system of the merchant or the computer system of the administrator to generate an electronic savings advertisement, the request comprising restrictions criteria; and
providing on the electronic savings advertisement transaction interface web page means for automatically restricting the number of transactions conducted with the savings advertisement enabling a customer to receive a promotional rate on a good or service according to the restrictions criteria.

15. The method of claim 9, further comprising delivering an electronic savings advertisement transaction interface web page from the server system to a portable web-enabled device of the customer, the savings advertisement transaction interface web page including an offer for the savings advertisement and means for receiving at the portable device of the customer a reservation request for the electronic savings advertisement; and
decrementing the available numeric quantity by one in the server system in response to the reservation request.

16. The method of claim 15, further comprising providing in the electronic savings advertisement transaction interface web page means for conducting a transaction with the savings advertisement enabling a customer to receive a discount on a good or service either during a purchase at a point of sale or during a future purchase; and
decrementing the available numeric quantity by one in the server system in response to the transaction conducted with the savings advertisement enabling a customer to receive a discount on a good or service.

17. A method of reserving an electronic savings advertisement comprising:
delivering an electronic savings advertisement creation interface web page from a server system to a computer system of a merchant or a computer system of an administrator, the electronic savings advertisement creation interface web page providing means for creating different types of savings advertisements;
receiving at the server system a request from the computer system of the merchant or the computer system of the administrator to generate an electronic savings advertisement, the request comprising a maximum number of transactions that can be conducted with the electronic savings advertisement;
storing in the server system a value representing an available numeric quantity for the electronic savings advertisement;
determining in the server system whether the numeric quantity is greater than zero;
delivering an electronic savings advertisement transaction interface web page from the server system to a computer system of a customer, the savings advertisement transaction interface web page including an offer for the savings advertisement, means for conducting a transaction with the savings advertisement enabling a customer to receive a discount on a good or service either during a purchase at a point of sale or during a future purchase, and means for conducting a transaction to create an electronic record of the savings advertisement;
decrementing the available numeric quantity by one in the server system in response to each transaction conducted with the savings advertisement;
restricting another customer from conducting a transaction with the savings advertisement if the available numeric quantity is zero;
receiving at the computer system of the customer the electronic savings advertisement record; and
providing in the electronic savings advertisement transaction interface web page means for locating the electronic savings advertisement record means for conducting a transaction with the electronic savings advertisement record enabling a customer to receive a discount on a good or service either during a purchase at a point of sale or during a future purchase.

18. The method of claim 17, further comprising providing on the server system means for uniquely identifying a customer while the customer is using the electronic savings advertisement transaction interface web page;
providing on the electronic savings advertisement creation interface web page means for associating with an electronic savings advertisement restrictions criteria;
receiving at the server system a request from the computer system of the merchant or the computer system of the administrator to generate an electronic savings advertisement, the request comprising restrictions criteria; and
providing on the electronic savings advertisement transaction interface web page means for automatically restricting the transactionss conducted with the savings advertisement according to the associated restrictions criteria.

19. The method of claim 17, further comprising storing a maximum transaction time, determining whether the maximum transaction time has passed from the time of the transaction to generate the electronic record without a transaction being conducted with the electronic savings advertisement record enabling a customer to receive a discount on a good or service; and
incrementing the available numeric quantity by one in the server system.

20. The method of claim 17, further comprising delivering an electronic savings advertisement transaction interface web page from the server system to a portable web-enabled device of the customer, the savings advertisement transaction interface web page including an offer for the savings advertisement, means for conducting a transaction with the savings advertisement enabling a customer to receive a discount on a good or service either during a purchase at a point of sale or during a future purchase, and means for means for conducting a transaction to create an electronic record of the savings advertisement;
receiving at the portable device of the customer the electronic savings advertisement record; and
providing in the electronic savings advertisement transaction interface web page means for locating the electronic savings advertisement record and means for conducting a transaction with the electronic savings advertisement record enabling a customer to receive a discount on a good or service either during a purchase at a point of sale or during a future purchase.
